(19) United States
(12) Patent Application Publication
(10) Pub. No.: US 2025/0299236 A1
(43) Pub. Date: Sep. 25, 2025

(54) SYSTEMS AND METHODS FOR ANONYMOUS MATCHING OF PRINCIPAL PARTIES AND ASSISTING AGENTS

(71) Applicants: Gary Joseph BRINCAT, Commerce Township, MI (US); Scott Walter FADER, Oxford, MI (US)

(72) Inventors: Gary Joseph BRINCAT, Commerce Township, MI (US); Scott Walter FADER, Oxford, MI (US)

(21) Appl. No.: 19/082,401

(22) Filed: Mar. 18, 2025

Related U.S. Application Data
(60) Provisional application No. 63/567,213, filed on Mar. 19, 2024.

(51) Int. Cl. G06Q 30/0601; G06Q 30/018; G06Q 50/16

(52) U.S. Cl. CPC G06Q 30/0611; G06Q 30/018; G06Q 50/16

(57) ABSTRACT

An illustrative embodiment includes a system having a processor configured to receive transactional-service identifying information and a request for assistance from an agent pre-qualified to assist with the transactional-service. The system uses criteria pre-associated with qualified assisting agents to anonymously match candidate agents to a principal party submitting the request-maintaining bi-directional anonymity of contact information between the agents and principal party. Agents may use templated forms to submit competitive offerings that are conveyed, anonymously, to the principal party. Upon principal party agreement to one of the competitive offerings, the contact information may be bi-directionally exchanged in response to the agreement by the principal party. Withholding some or all contact information until an agreement is at least tentatively reached between agent and party can protect the personal data of the principal party, and/or agent, until a time when one or both parties may be willing to exchange such data.

### CROSS-REFERENCE TO RELATED APPLICATIONS

This application claims the benefit of U.S. provisional application Ser. No. 63/567,213 filed Mar. 19, 2024, the disclosure of which is hereby incorporated in its entirety by reference herein.

### TECHNICAL FIELD

The present disclosure relates to a system and method for anonymous matching of principal parties and assisting agents. More specifically, the present disclosure relates to systems and methods that include, but which are not limited to, principal seeking to obtain or dispense of real property to receive one or more anonymous communications from one or more actors or agents qualified to assist the user in the sought-after action.

### BACKGROUND

Full-service assisting agents, such as, but not limited to, real estate agents, as buying agents, may not be willing to contribute to the closing costs of a particular principal party, such as, but not limited to, a buyer, of real property. Similarly, full service assisting agents, such as, but not limited to, selling agents, may not be willing to reduce commissions associated with a particular principal party, such as, but not limited to, a seller of real property. Likewise, other entities, such as, but not limited to, mortgage brokers, bankers, etc., may not be willing to contribute to the closing costs of a particular principal party to reduce closing costs associated with the particular party.

A person seeking to obtain real estate, a principal party, such as, but not limited to, the buyer of a home, may directly interview one or more assisting agents. This may result in the principal party ultimately engaging or acquiring an assisting agent to work on their behalf to find a suitable home. Similarly, a principal party, such as, but not limited to, a seller of real estate, may directly interview one or more assisting agents and likewise engage or acquire an assisting agent to work on the principal party's behalf to sell the real estate.

Since many such searches are now transacted remotely or using technological assistance, principal parties seeking assisting agents may seek the assisting agent online. Such a process may involve, for example, submitting user-identifying information. Problematically, however, such information can be used by many parties to many ends. The principal party has no assurances that they are getting the best, or even a good value, and they have relinquished potentially significant personal information in exchange to even be contemplated. They may be subjected to endless electronic communication and advertising as a result, without even knowing if there was a fair value exchange, and have no ability to terminate the endless electronic communication once initiated. Principal parties who do not typically transact in such business have limited ability to evaluate the fairness of offerings, and limited ability to comparatively assess offerings.

Moreover, in even simply seeking multiple competitive positions, the personal data may have to be relinquished repeatedly for each offering sought, amplifying the effects of spam or other unrequested communication. Finally, although the principal party may complete an agreement with a particular assisting agent, and even if the agreement is fair in value, there are no assurances that all the unwanted communication will cease, for months or even years.

### SUMMARY

In a first illustrative embodiment, a non-transitory computer readable storage medium stories instructions that, when executed, configure a processor executing the instructions to perform a method that includes receiving input from a principal party seeking assistance with a transactional service, wherein the assistance is sought from at least one assisting agent predefined as qualified to assist with the transactional service and wherein the input includes identification of the at least one transactional service. The method also includes receiving input from a first plurality of assisting agents, including at least first information indicative of one or more credentials and usable to verify at least one of the one or more credentials and including at least second information identifying at least one area where an inputting assisting agent is qualified, based on at least one of the one or more credentials, to offer assistance with one or more transactional services. The method further includes identifying a second plurality of assisting agents, from the first plurality of assisting agents, determined, based on predefined criteria, to be eligible to assist the principal party with the at least one transactional service. Also, the method includes providing the second plurality of assisting agents with a competitive offering template related to the at least one transactional service, the template determined at least in part based on a predefined nature of the at least one transactional service and having a plurality of predefined alterable fields related to the at least one transactional service. The method includes receiving one or more completed templates from the second plurality of assisting agents and providing one or more sets of information indicative of the information included in the one or more completed templates to the principal party in a selectable manner, whereby the principal party can select at least one of the sets of information to signal a desire to engage a particular assisting agent responsible for completing a respective template from which the at least one set of information was derived. The method further includes, responsive to selection of the at least one of the sets of information, exchanging contact information of the principal party with the particular assisting agent and contact information of the particular assisting agent with the principal party, the contact information of both the principal party and the particular assisting agent having been withheld such that the plurality of second agents lacked the contact information of the principal party at least while completing the competitive offering template and such that the principal party lacked the contact information of the second plurality of assisting agents prior to selection of the at least one set of information.

In a second illustrative embodiment, a non-transitory computer readable storage medium stores instructions that, when executed, configure a processor executing the instructions to perform a method including receiving a request for assistance from an assisting agent to assist with a transactional service identified as part of the request and determining a first set of criteria for assisting agents that includes one or more assisting agent characteristics indicative of suitability of a given assisting agent for providing assistance with the transactional service. The method further includes identifying a plurality of assisting agents having predefined profiles including one or more elements that correspond to a predefined minimum number of the assisting agent characteristics. Also, the method includes providing templates to the identified plurality of assisting agents for obtaining data, corresponding to a plurality of fields within the templates, indicative of a competitive offering from a respective agent to assist with the transactional service and wherein receipt, by at least one of the plurality of assisting agents, of contact information, corresponding to a principal party on whose behalf the request was received and identified with the request, is predicated on completion of the template within a predetermined time period and acceptance, by the principal party, of assistance of a given of the plurality of assisting agents. The method includes receiving a plurality of the templates having been completed and representative of a plurality of competitive offerings and sending information indicative of the plurality of competitive offerings to the principal party, wherein receipt of contact information, by the principal party, for a given assisting agent responsible for a given of the plurality of competitive offerings, is predicated on acceptance, by the principal party, of the given competitive offering associated with the given assisting agent. The method also includes receiving indication that the given competitive offering has been accepted by the principal party and, responsive to the acceptance of the given competitive offering, providing the contact information corresponding to the principal party to the given assisting agent associated with the accepted given competitive offering and providing the contact information for the given assisting agent to the principal party.

### BRIEF DESCRIPTION OF THE DRAWINGS

FIG. 1 shows an illustrative, non-limiting schematic illustration of a representative network in which the present embodiments may be implemented;

FIG. 2 shows an illustrative, non-limiting flow, illustrating a non-limiting example of an implementation of an anonymous bidding system, process or method;

FIGS. 3A and 3B show an illustrative block diagram of an implementation of a system or method for anonymous competitive offerings;

FIGS. 4A and 4B show illustrative process flows for an implementation of a system or method for anonymous competitive offerings;

FIG. 5 shows an illustrative example of an agent form;

FIG. 6 shows further illustrative examples of agent information forms;

FIGS. 7 and 8 show illustrative principal party forms;

FIGS. 9 and 10 show illustrative assisting agent forms;

FIGS. 11 and 12 show illustrative examples of screenshots for a principal party receipt of a competitive offering;

FIGS. 13 and 14 show non-limiting examples of screenshots for an implementation of a portal for a particular seller of real property;

FIG. 15 shows illustrative screenshots for an implementation of a portal for an assisting selling agent;

FIG. 16 shows an illustrative screenshot of an implementation of a portal for a qualified real estate selling agent;

FIG. 17 shows an illustrative screenshot of an implementation of a portal for a qualified real estate buying agent;

FIGS. 18-29 show illustrative implementations of an message notification from the system to various parties to a transaction indicating the various statuses of the pending or accepted transactions, expectations, requirements, next-steps, etc.

### DETAILED DESCRIPTION

As required, detailed, illustrative and non-limiting examples of embodiments of the present invention are disclosed herein. It is to be understood that the disclosed embodiments are merely exemplary and illustrative of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the intent of the disclosure are intended to be within the scope of the invention.

For purposes of illustration, examples of embodiments are provided exemplifying relationship formation between principal parties and assisting agents seeking to engage in real property transactions, but the embodiments are not limited to such. Appreciable comparable scenarios, to which the embodiments would apply, are understood by skilled artisans and the disclosure is envisioned to extend thereto.

The illustrative embodiments, and the like, provide a system that improves the anonymity of remote transaction requests, protecting principal party personal data until such time as there is a meaningful and/or acceptable reason, from at least the perspective of the principal party, for the principal party to relinquish the data, and/or such time as the principal party has assurances that the entity to whom the data is being relinquished is a legitimate entity with whom the principal party desires to transact.

It is a common occurrence for requests for virtually any service on the Internet to require entry of an email address and/or personal information, such as an address. Providing such information immediately exposes the information-provider to a potentially endless stream of unwanted advertising, and, in many instances, the information-provider does not even know that the website or form is being forwarded to the appropriate party, such as a desired assisting agent. Information-providers can include, for example, principal parties seeking transactions, as well as other parties seeking transactions, and any reference herein to “principal party,” is not intended to exclusively limit such reference to a particular party, not is any reference to “assisting agent” intended to exclusively limit such reference to a particular agent or type of agent, unless otherwise indicated. Thus, while buyers and sellers of real property are contemplated as at least examples of principal parties, and while real estate agents, brokers and banks are contemplated as assisting agents or entities, such disclosures are not limited thereto unless otherwise indicated or claimed.

Dummy websites, provided for fraudulent reasons, whether the reasons simply be to obtain advertising opportunity or something more nefarious, exist in droves across the Internet. They appear legitimate and unsophisticated users cannot usually tell if a website is valid or not. Even if the website is valid, there is little a user can do from preventing the website from selling the user's personal information or distributing the information to any number of advertisers, once such information has been provided to the site.

In most instances, a principal party is more than willing to relinquish all suitable information once a relationship has been established or some assurances of trust have been created. Often, some amount of information may ultimately be necessary to finalize the relationship. At the same time, the principal party may not want the information in the hands of any number of actors with whom the principal party ultimately did not decide to form a relationship, and certainly not in the hands of irrelevant (to the transaction) bad actors, and yet there remain very few digital ways, e.g. suitable platforms, for information-providers, such as principal parties, to avoid exchanging such information before the relationship and/or trust is established.

Even in the instances where a principal party may willingly provide information up front, the principal party may have to go through the search and submission process many times before a relationship is ultimately established, which can lead an unsophisticated, or simply tired, principal party to accept a bad deal out of frustration, lack of knowledge, fear of data-exposure, etc.

While entry into a binding agreement between an assisting agent and a principal party may still ultimately require mutual personal identity, the illustrative embodiments, and the like, permit engagement or acquisition of an assisting agent, broker, banker, etc., by a principal party while potentially avoiding revealing personal information until a time that is acceptable to both parties. Further, the illustrative embodiments, and the like, provide for the user to avail themselves of a competitive process. Ultimately, the system provides increased and improved anonymity of principal party data, protecting such data from unintentional or misguided dissemination, while not preventing the principal party from seeking services for which such data may ultimately be pertinent.

Currently, there appear to be no processes, systems, platforms, etc. for a primary or principal party (e.g., without limitation, a buyer or seller of real property) to anonymously find one or more assisting agents (e.g., without limitation, real estate buying or selling agents) who, in turn, may assist in finding a counter-party for the primary or principal party.

The illustrative embodiments, and the like, provide systems and methods wherein the principal party may be in control via an anonymous electronic interaction. The interactions may be between, but are not limited to, a particular principal party and one or more qualified assisting agents. The principal party can anonymously seek competitive offers for services associated with a particular qualified assisting agent. This can include submissions from a plurality of assisting agents to the principal party, and such submissions may be anonymized with respect to various aspects of information included therein, as indicated herein and/or as understood to be appropriate for a given transaction/submission.

In at least one non-limiting example, input associated with the primary party can be used to control the process in an electronically interactive manner while maintaining partial or complete anonymity until the primary party accepts a particular submission associated with a particular qualified assisting agent.

Facilitation of aspects of the illustrative embodiments may include, for example, but is not limited to, use of a standardized bid template. A non-limiting instance thereof may comprise one or more minimum service aspects of components allowing each qualified agent or finder to independently, separately and anonymously update their competitive position. This anonymity and/or updatability can level the playing field between unsophisticated principal parties and sophisticated assisting agents, allowing the principal party to rapidly choose or select the optimal service, cost and/or fee combination, while preserving their anonymity thoughout the process until a suitable time.

Among other things, the proposed systems and methods, and the like, for assisting agents to anonymously submit proposals to principal parties can allow for assisting agents to thereby contribute to the closing cost (or other appropriate factor) of a particular principal party or reducing commissions (or other appropriate factor) to a particular principal party. At the same time, the assisting agent is not viewed as unsolitcitedly or solicited advertising to those principal parties, but can still immediately and/or exclusively receive the personal contact information of an accepting principal party.

Furthermore, aspects of the illustrative systems and methods, and the like, allow the principal parties to anonymously post limited property-related information, personal information, classifieds, etc. and to solicit competitive positions (such as offers and/or pricing) from each qualified and interested assisting agent, thereby allowing an assisting agent to offer to contribute to the principal party's closing costs or offer to reduce the principal party's commission while maintaining or improving the overall service level to the principal party.

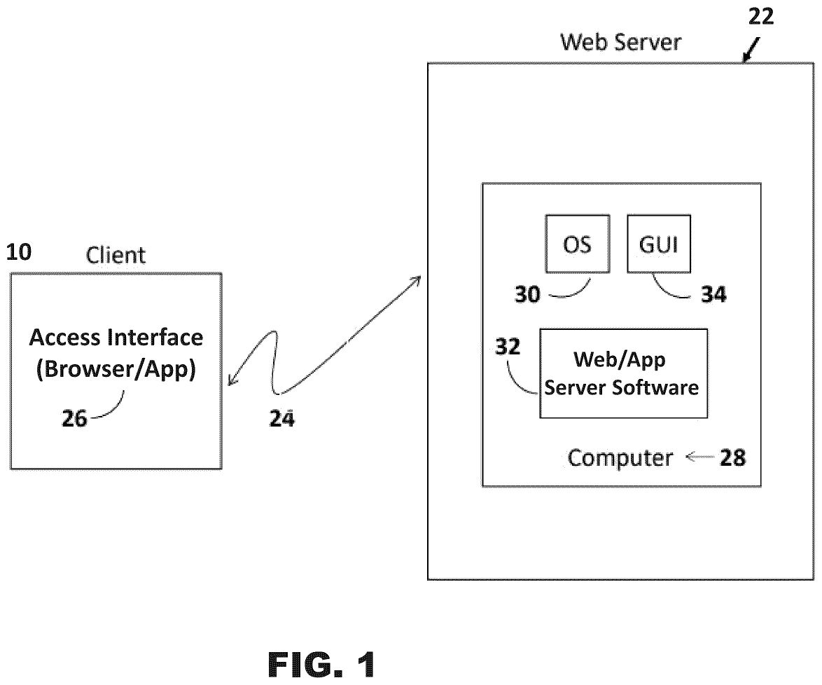

FIG. 1 shows an illustrative, non-limiting schematic illustration of a representative network in which the present embodiments may be implemented. A client 10 can access a browser 26 to interact with webserver 22 through connection 24. Such interaction can be on a mobile device or computer equipped with a browser. In other implementations, the access can be achieved through use of a mobile application interfacing with web server 22.

In the browser example shown, the webserver 22 may include web server software 32, which can provide the user browser 26 with a graphical user interface 34. The web server software may provide various aspects of the illustrative embodiments, as appropriate. When the client 10 uses an application, the interface may be provided with the application, and aspects of the processes can be performed at the client device, web server, or a combination of the two, as appropriate for a given implementation.

The network may include a client machine 10 connected to a Web Server 22 via a communication channel 24. The channel 24 could be the Internet, an Intranet or other known connection channel type. In the case of the Internet, the web server 22 may be one of a plurality of servers that are accessible by a plurality of clients such as the client machine 10. By way of example, the client machine 10 may be a personal computer such a desktop or notebook running a Windows operating system or a smart phone such as an Apple iPhone running an Apple operating system (iOS) or an Android phone running its (Linux) operating system.

Another example may include a smart phone running an operating system. The client machine 10 may include browser 26, used to access the servers of the network. Client machines may communicate with servers by using the TCP/IP protocol suite.

By way of example, the Web Server 22 may a server on a computer 28 running the Operating System 30 and a Web server program 32 that support interface extensions. Various other suitable hardware/operating system/web server program combinations are possible including by way of nonlimiting example, hosted servers. The server 22 may also include a graphical user interface (GUI) 34 for management and administration, The Web server 22 may operate a web site and support files in the form of documents and pages. A network path to a Web site generated by the server is identified by a Universal Resource Locator (URL). A URL is a reference (or address) of a given unique resource on the Web or to a resource on the internet. In theory, each valid URL points to a unique resource.

Additional resources beyond those cited above may include industry standard programming tools, environments, databases and other components including MySQL, java, programmatic email handling and text handling software, etc. These may be employed as part of curating and/or customizing a standardized bid template employable by both a particular buyer of real property and each qualified real estate buying agent on a buyer-only site and a particular seller of real property and each qualified real estate selling agent on a seller-only site.

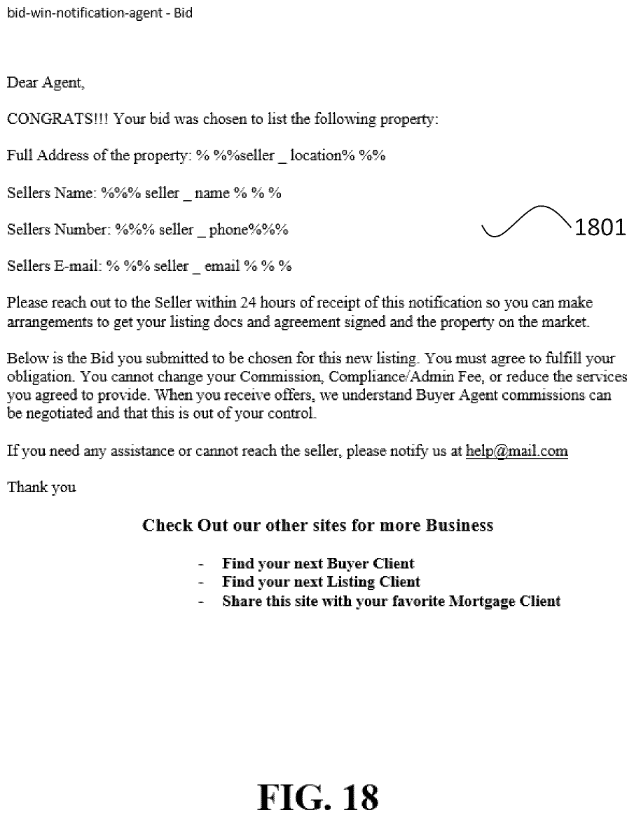

Participants are notified of important events or input typically by text and/or email in order to avoid having to constantly check the Web site for recent bids with anonymity thereby avoiding the typical badgering via phone calls or personal emails. Non-limiting examples of some of these notices are seen in FIGS. 18-29.

The notice may include a direct link (e.g., a direct hyperlink) to a portal comprising the particular input. By clicking on the link, the participant is automatically returned to their portal to review the particular input. In one implementation the disclosed system and method unlocks the supply of frontline real estate agents to the benefit of buyers and sellers of real property and is preferably implemented in an Internet environment, in one embodiment the Website to which the system is associated or hosted by a Web server (such as server 22). The Web site may be nationally accessible to either type of participant (i.e.1 buyers or sellers of real property) using individual client machines (smart phone or personal computer 10).

In an embodiment, a particular first type of participant e.g., a buyer or seller of a real property initially registers with the system. Thereafter, as will be described, the buyer or seller request to be made live on the site or system. A redacted property related notice is posted on the website as opposed to a detailed description of the property designed to attract a counter-party which is not a participant on the site. Registration involves accessing the Web site and inputting information associated with a buyer or seller including a username and password in a buyer registration form displayed as Web page on the buyer or seller's client machine 10.

The system allows a particular buyer or seller of real property to find a qualified real estate agent without searching or shopping. An anonymous interaction eliminates unwanted communication (e.g., junk email, text, calls etc.) from each non-accepted agent because no personal contact information is shared with any non-accepted agent.

One possible implementation of the disclosed system or site for anonymously bidding may include a particular type of buyer i.e., a first-time buyer of real property being referred or presented to the system or site by a mortgage professional e.g., loan officer, mortgage broker or mortgage banker. In order for the mortgage professional to have a better (or any) chance of qualifying or pre-approving the first-time buyer for a mortgage, the mortgage professional recommends that (1) the first-time buyer gains access to the site or system and (2) accepts a financial contribution from a particular qualified real estate buying agent on the site and (3) applies or reapplies with a? or the mortgage professional.

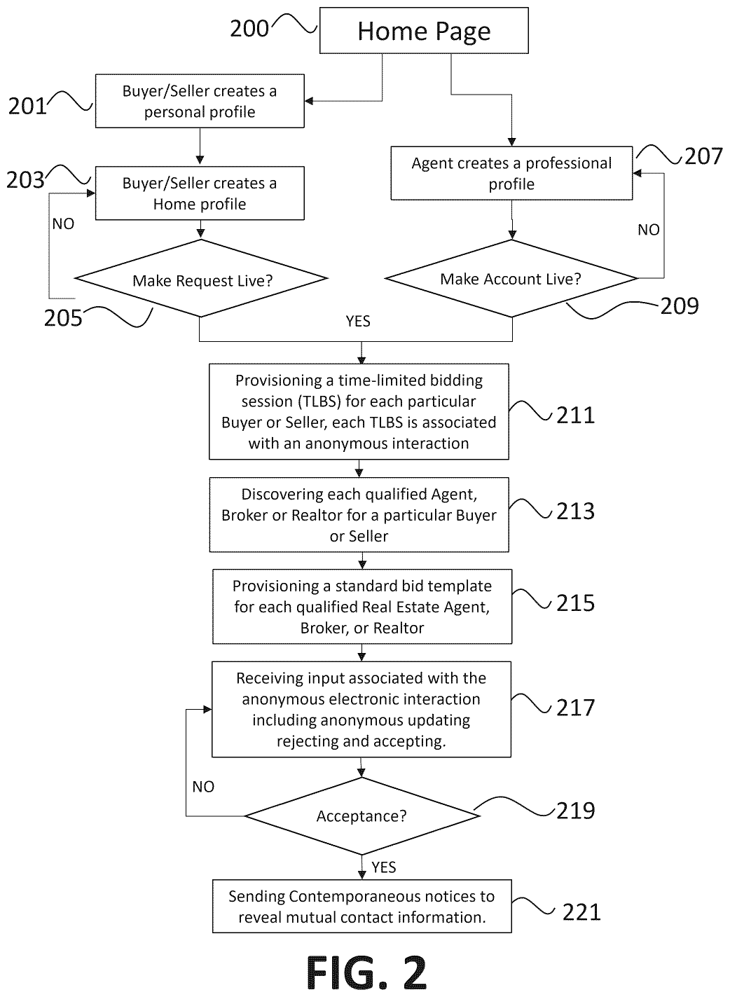

FIG. 2 shows an illustrative, non-limiting flow, illustrating a non-limiting example of an implementation of an anonymous bidding system, process or method. Principal parties and/or assisting a? enter the website at 200. Or, alternatively, they access various applications providing comparable capability with the home page understood to be replaced by a suitable primary page.

Principal parties can provide registration details to the system to create a profile at 201. The anonymity of these details may be maintained by the system until appropriate, or the principal party may create a limited-use profile with details to be provided later if the system does not require full details upon profile creation.

At 203, the principal party may create a home profile, including home specific information. It may be possible to withhold certain information, such as a specific address, at this point, provided, for example, there is sufficient detail for the assisting agent to make an offer. In other examples, the address may be provided along with other home details—e.g., without limitation, square footage, room details, etc., as would be pertinent to a real estate listing.

At some point following entry of details at 203, the principal party can make the request live at 205, which can cause the request to be delivered to one or more potential assisting agents at 211. Principal party details may remain anonymous. Any aspect of the principal party's profile may be, for example, selectable as “anonymous” or “visible,” as desired, or the entire profile may be mandated or selectable as anonymous or visible until certain conditions are met. Further, certain necessary details (as determined by the backend) may be required to be shared, and this may be visibly indicated to the profile-creator if desired.

Assisting agents may enter registration variables to the system at 207 to create an agent profile. These can include contact details, professional credentials, duration of service, etc., as would be appropriate for demonstrating credentialing and capacity as an assisting agent. The system may also verify any credentials verifiable with a professional organization, through an automated verification process, if desired.

At 209, the assisting agent may activate their account to commence receiving anonymous requests from principal parties. Agents may be matched to requests based on a variety of factors, including, but not limited to, experience, willingness to meet certain principal-party specified conditions (e.g., without limitation, maximum commissions), indicated preferences to act as an agent for certain types of principal parties, suitable geographic location, etc. In other examples, a pool of agents may be designated based on a general criteria—e.g., without limitation, geography—and all agents within the pool may be provided with a given request. In other examples, agents may be limited to a certain number of ongoing requests, bidding sessions, open contracts, etc., as deemed appropriate to protect the interest of the buyers.

Because the matching can be tuned, if desired and appropriate (e.g., within legal or profession guidelines), the system can also act as a pseudo-agent for the principal party, by ensuring criteria of agents and/or that a possible assisting agent is not overcommitted and thus may potentially provide substandard service. Ratings of agents may also be used for matching, if desired, again within legal, professional and/or agreed-upon parameters. Agents may agree to the use of certain criteria for matching when signing up, and the provider of the backend can ensure suitable compliance and transparency-of-process as necessary and appropriate. It is also appreciated that new or junior agents may not have as many established credentials, and so principal parties may agree to, or be required to, accept a certain predefined or random number of agents from a general pool in the match—i.e., in addition to a certain number of agents meeting specified criteria (e.g., without limitation, 5-star, 10 years experience, etc., there may be a certain number of additional agents added to the pool of agents.)

In the time-limited bidding session at 211, principal parties may define the timeframe during which they will accept anonymous offers and bids. This can be a fixed timeframe, based on a certain number of bids being received, or open-ended until a bid is accepted. Other suitable duration criteria may also be defined.

At 213, principal party anonymous requests may be received by participating assisting agents. These requests may go to any number of agents, a predefined random number of agents, all agents within a certain area, all agents meeting certain criteria, etc. Other sorting of candidates could also occur as suitable or previously described herein. Using a standardized templet, for example, assisting agents may complete the forms, which can be anonymously returned to the principal parties. In this example, anonymity may work both ways, with the principal party being unable to see certain details about the agent until a bid is accepted. Any other suitable amount of necessary or desired information about the agent may also be shared. Principal parties may, for example, be informed in advance of the details that will or will not be shared. In still further examples, premium access or pay-for-details services may provide certain details with permission of the system or an agent—e.g., without limitation, buyers may be able to pay to see certain or all details about bidders. In still further examples, certain details may be revealed once a certain number of bids are accepted for consideration—e.g., without limitation, if a principal party accepts multiple close bids, they may see the details, while the bidders may be given a chance to re-bid before a final selection is being made. It is appreciated that price alone may not be a singular criteria for agent selection, and thus, to the extent some or all agent details are anonymized, certain of those details, at least, may be revealed before a final relationship is engaged. Principal parties may also request details before final engagement—e.g., make engagement predicated on revealing certain information.

In certain instances, at least, the offers are non-binding—i.e., the agents and/or principal parties are simply agreeing to likely terms. Then, when contact information is provided at 221, the deal can be finalized. Thus, a principal party who carefully guards their information may only wish to transact with certain agents, and hence, in certain examples, the principal party may, for example, pay a premium to find out additional information before contact-exchange. In other instances, all agents may remain anonymous or semi-anonymous prior to exchange. Details that could allow for an agent or principal party to circumvent any dues to the service provider may be omitted, for example, so as to avoid using the platform as a “shopping expedition” and then avoiding any cost due to the platform based on a match. If the platform-provider is unconcerned about this, for example, any and all suitable details may be provided.

At 217, the principal parties can now review, side by side or in any other suitable manner, multiple anonymous bids and offers. This can include whatever information about the agents that has been provided or deemed acceptable to provide or necessary by the principal party. At 219, following the review of the bids and offers, principal parties can accept or reject any of the offers. In another example, the principal parties may be able to choose several offers and send them for rebid. Assisting agents may stand firm or change their numbers based on how much they believe that the pricing matters. Such rebidding and/or rejections could also include a counteroffer from the principal party, if appropriate.

While any accepted bids and/or accepted counteroffers may be non-binding and reliant upon in-person completion of appropriate contractual obligations, such counteroffers may also be binding, if desired and legally permissible. Such counters may go to a “first to respond” agent, or may be given primacy for that agent provided that certain agent criteria be suitable and be un-anonymized. If desired, principal parties may be obligated to define acceptable criteria in advance, and then the first to accept agent who meets the criteria would be engaged. This could also include, if desired, provision of near-matching or other criteria from an accepting agent to the principal party, if the accepting agent did not meet any predefined criteria specified by the principal party.

At 221, once a principal party accepts the bid or offer of one of the submissions, the system may disclose the contact information to both parties. Such disclosure may be delayed until any remaining details are worked out, if necessary, such as, but not limited to, matching of other criteria, or any other assurances necessary for the principal party. In some instances, the principal party, in order to participate, may be obligated to accept the match as acceptable, trusting in the system to provide suitable agents through the anonymous process. The result of step 221 can include the principal party receiving the agent's contact information, and the agent receiving the principal party's contact information.

The flow chart of FIG. 2 illustratively depicts associating two or more input variables, fields or parameters with a standardized bid template or instance thereof. In one implementation, the standardized bid template provisioned by software associated with the site or system comprises one or more service aspects of components.

Standardized bid templates may be utilized for each qualified real estate buying agent with mandatory service aspects or components comprising (1) arranging appointment, (2) accepting/presenting offers, (3) advising on offers, (4) assisting with counter-offers and (5) negotiating for buyer. There may be associated checkboxes (Boolean variables) that are pre-checked because the five (5) aspects or components represent a common minimum requirement on each qualified real estate buying agent.

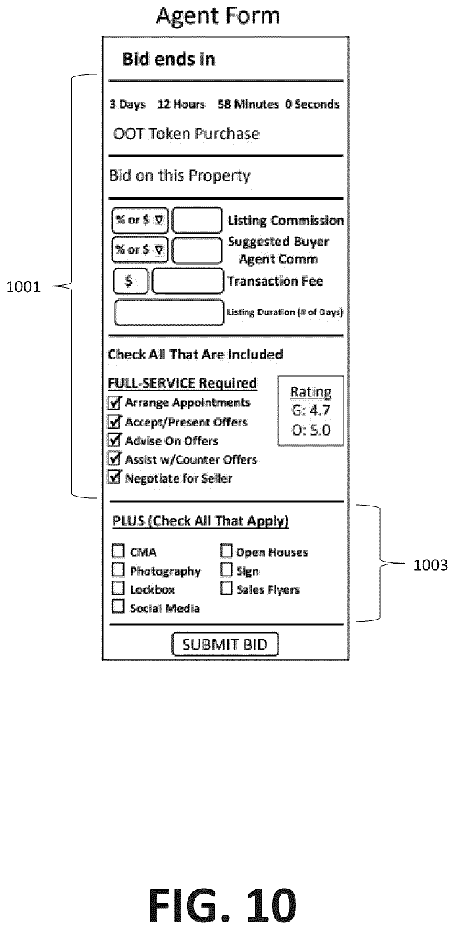

FIG. 10 represents another implementation that includes a standardized bid template for each qualified real estate selling agent with minimum service aspects or components that comprise (1) arrange appointments, (2) accept/present offers, (3) advise on offers, (4) assist with counter-offers and (5) negotiate for buyer. Again, there may be associated checkboxes (Boolean variables) that are pre-checked because the five (5) service aspects or components represent a minimum requirement on each qualified selling agent. However, in the case of a selling agent the standardized bid template may also comprise optional aspects or components including a.) Signs, b.) CMA, c.) Photography, d,) Lockbox, e.) Social Media, f). Open Houses, g.) Sale Flyers. There are associated checkboxes (Boolean variables) that are not pre-checked because these seven (7) aspects or components are to be optionally selected by each qualified real estate selling agent.

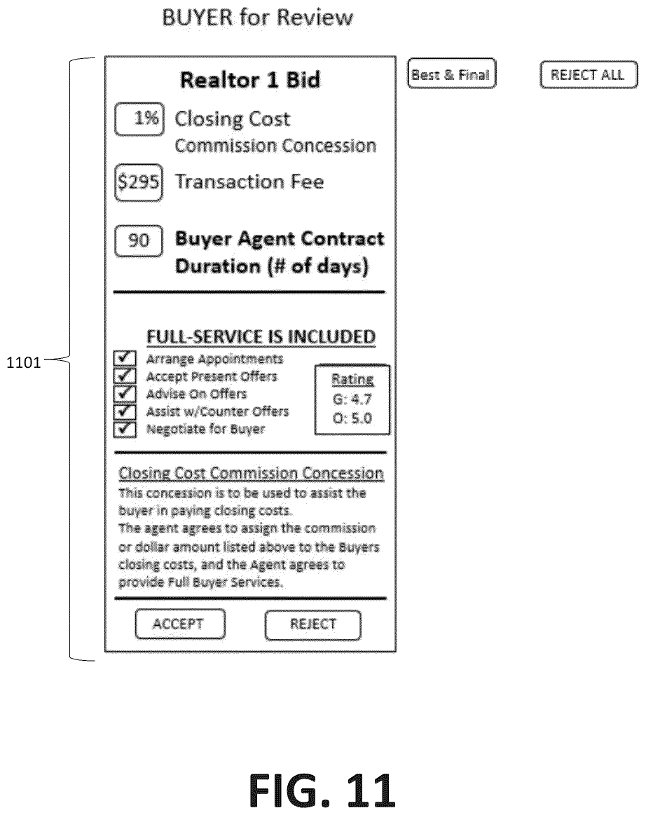

FIG. 11 represents a reflected-back buyer view of the standardized bid template associated with a qualified buying agent and similarly FIG. 10 represents a reflected-back seller view of a standardized bid template associated with a qualified selling agent.

FIG. 2 also depicts receiving input associated with a real estate agent. In one implementation receiving input associated with a real estate agent comprises receiving an email address, cell phone number and one or more state IDs wherein each state ID is related to a geographical location or area via a state license held by the agent. The email address may be used as the recipient address by the system to anonymously send communication such as email or text notices on behalf of a particular sender e.g. a buyer or a seller.

The email address may also be employed to create a member ID for the agent in a national database. The email address may also be employed to create a member ID for a buyer, seller or real estate agent in a national database associated with the site or system.

FIG. 2 also depicts receiving input associated with a real estate agent in one implementation receiving input associated with a real estate agent comprises receiving an email address, cell phone number and one or more state IDs wherein each state ID is related to a geographical location or area via a state license held by the agent. The email address may be used as the recipient address by the system to anonymously send email or text notices on behalf of a particular sender e.g. a buyer or a seller and the email address may also be employed to create a member ID for the agent in a national database. The email address may also be employed to create a member ID for a buyer, seller or real estate agent in a national database associated with the site or system.

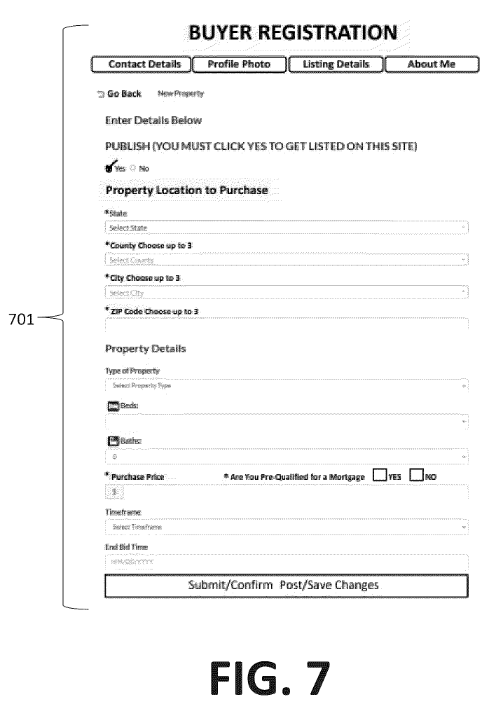

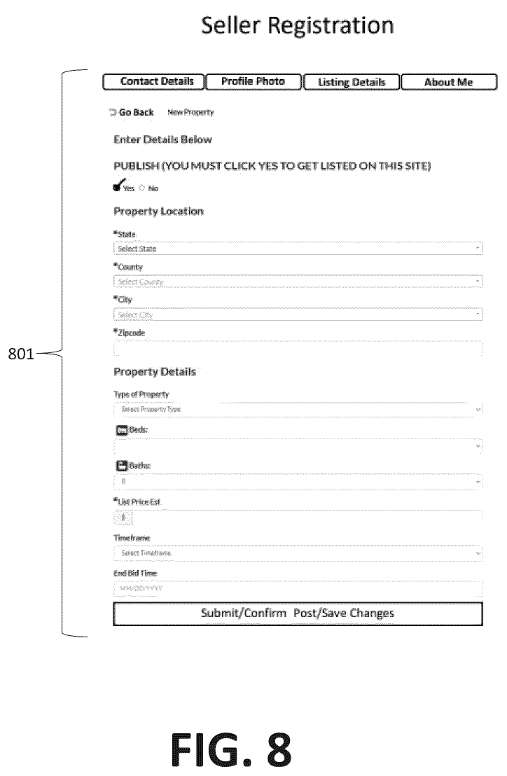

FIG. 2 also depicts receiving input associated with a particular buyer or seller of real property. FIGS. 7 and 8 represent an implementation receiving input associated with a particular buyer and seller that includes an email address, state identifier wherein the state ID is related to the geographical location or area of an existing property of a seller or of a future property of a buyer, cell phone number and timeframe or duration of a TimeLimited or BidLimited Bid session (TLBS or BLBS).

In one implementation, receiving input associated with a real estate agent comprises receiving an email address, cell phone number and one or more state IDs wherein each state ID is related to a geographical location or area via a state license held by the agent. The email address may be used as the recipient address by the system to anonymously send email or text notices on behalf of a particular sender e.g. a buyer or a seller and the email address may also be employed to create a member ID for the agent in a national database. The email address may also be employed to create a member ID for a buyer, seller or real estate agent in a national database associated with the site or system. The email address may be used by the site or system as the recipient address in order for the system or site to anonymously send emails on behalf of a particular sender. The email address may also be employed to create a member ID for a buyer, seller in the national database associated with the site or system.

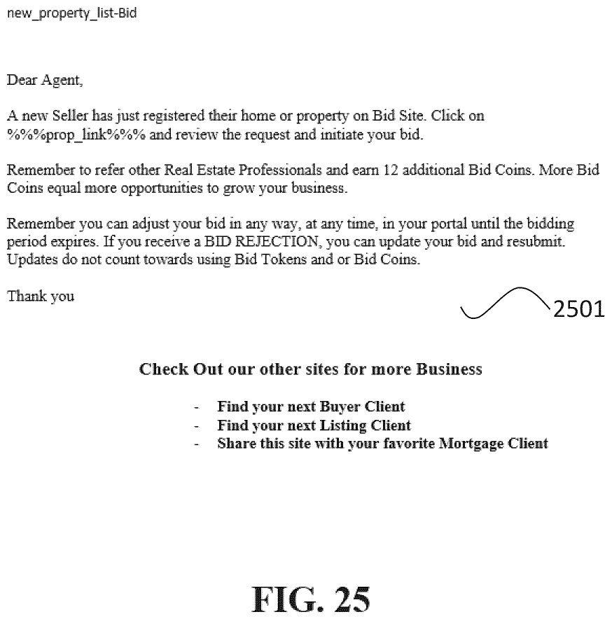

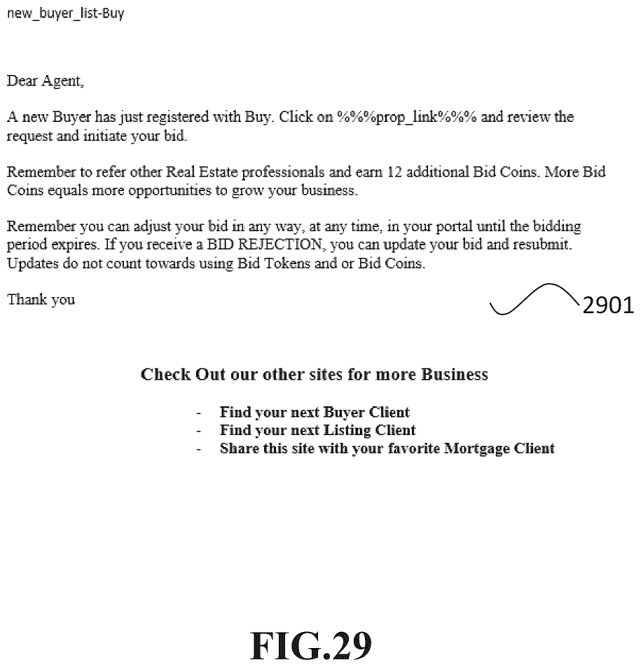

FIG. 2 also depicts a particular buyer or seller made live on the site or system. FIG. 25 represents an illustrative email from the system or site on behalf of a new seller being made live on the site or system. The email is sent to each qualified real estate selling agent associated with the new seller. Similarly, FIG. 29 represents an email from the system or site on behalf of a new buyer being made live the site or system. The email is sent to each qualified real estate buying agent associated with the new seller.

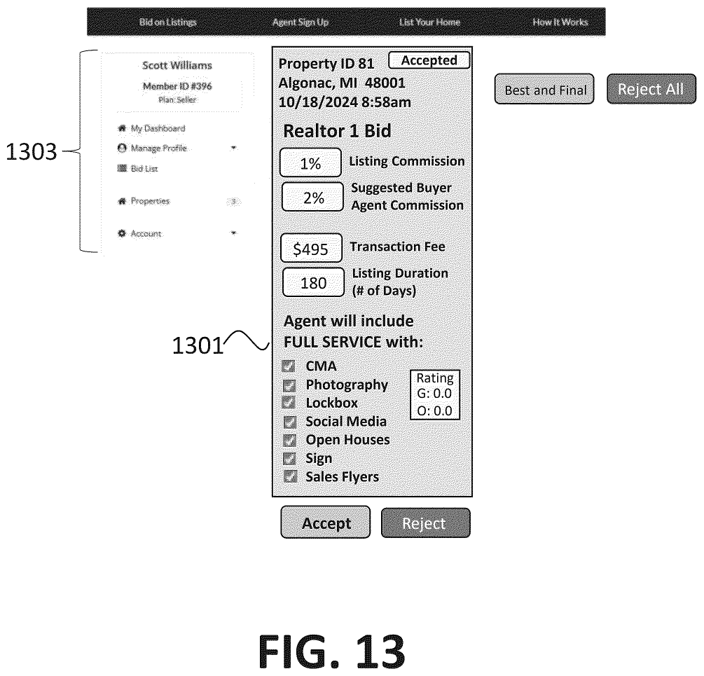

FIG. 2 also depicts provisioning a Time-Limited Bid Session (TLBS) or a BidLimited Bid Session (BLBS) for each particular buyer or seller. Each TLBS or BLBS may be associated with an anonymous electronic interaction. FIG. 11 shows an illustrative portal for a particular buyer of real property comprising a countdown timer initiated as part of provisioning the time-limited bid session for the particular buyer. Similarly, FIG. 13 shows an illustrative portal for a particular seller of real property comprising a countdown timer initiated as part of provisioning the time-limited bid session. A standardized bid template, or customized view or reflection thereof, is devoid of personal contact information thereby maintaining anonymity during the anonymous electronic interaction.

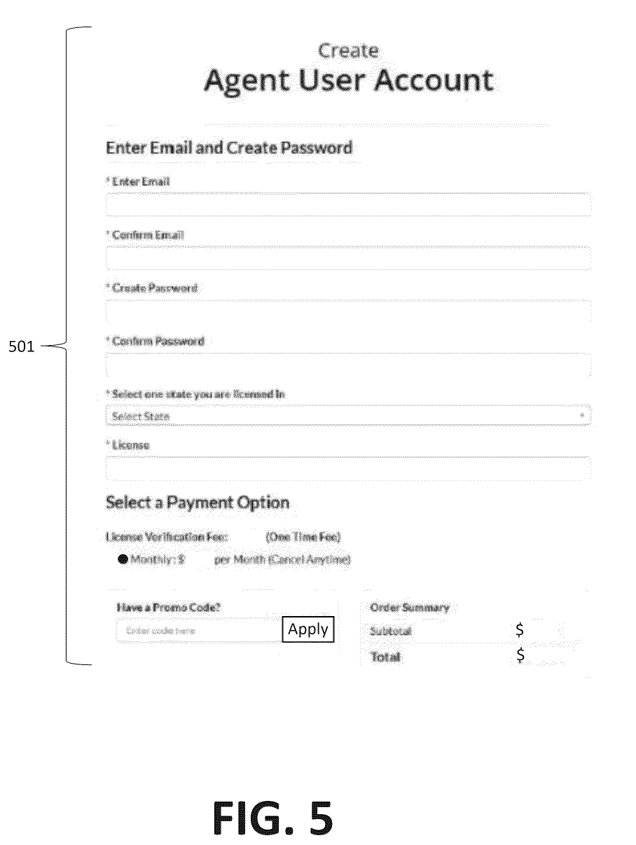

FIG. 2 also depicts discovering each qualified agent for a particular buyer or seller. FIG. 7 discloses receiving a state ID for a particular buyer of real property and FIG. 8 discloses receiving a state ID for a particular seller of real property. Similarly, FIG. 5 discloses receiving a state ID for a real estate buying or selling agent. The state ID of a particular buyer of real property is employed by the system to discover each qualified real estate buying agent. Each qualified real estate buying agent has a corresponding or matching state ID. Similarly, the state ID of a particular seller of real property is employed by the system to discover each qualified real estate selling agent. Each qualified real estate selling agent has a corresponding or matching state ID.

FIG. 2 also depicts provisioning a standardized bid template for each qualified real estate agent associated with the particular buyer or seller.

FIG. 2 also depicts receiving input associated with the anonymous electronic interaction. This includes anonymously updating, rejecting and accepting the state of the standardized bid template. This can include, for example: (1) buyer agents updating i.e. submitting a multi-dimensional bid, (2) seller agent updating i.e. submitting a multi-dimensional bid, (3) buyer rejecting, accepting, rejecting all and/or requesting a best and final bid; (4) seller rejecting, accepting, rejecting all and/or requesting a best and final.

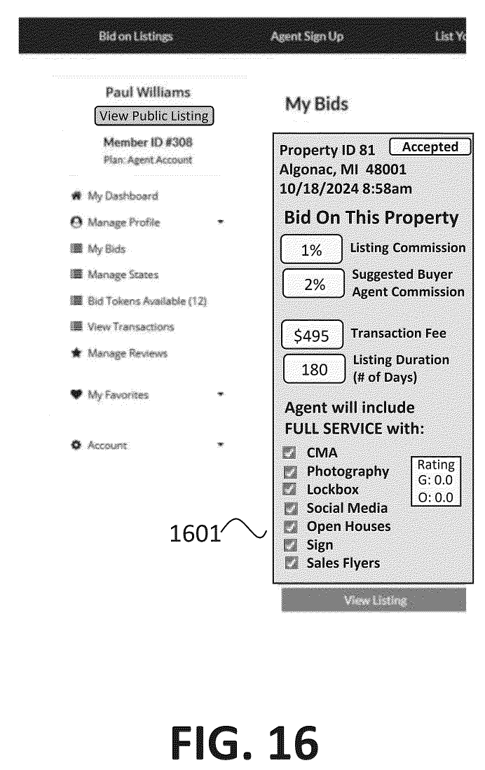

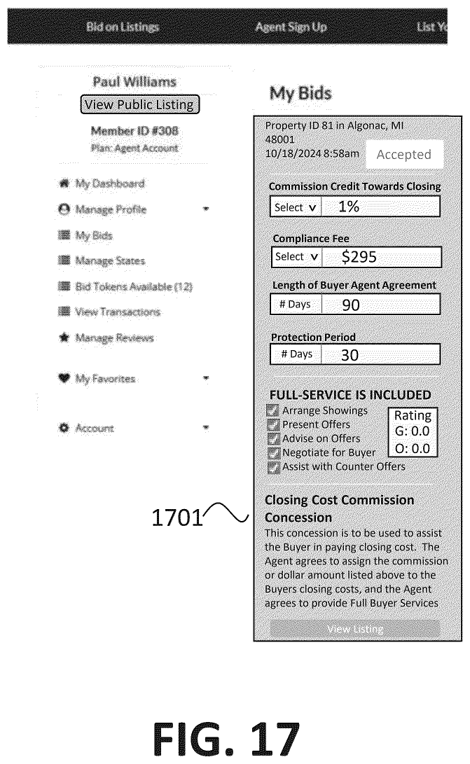

FIG. 2 also depicts Accepting the state/bid of/via a standardized bid template. FIG. 16 represents a portal for a real estate selling agent comprising a standardized bid template wherein the particular seller or real property has accepted the state of the standardized bid template associated with the selling real estate agent. FIG. 17 represents a portal for a real estate buying agent comprising a standardized bid template wherein the particular buyer of real property has accepted the state of the standardized bid template associated with the real estate buying agent. STB within a Portal Receiving.

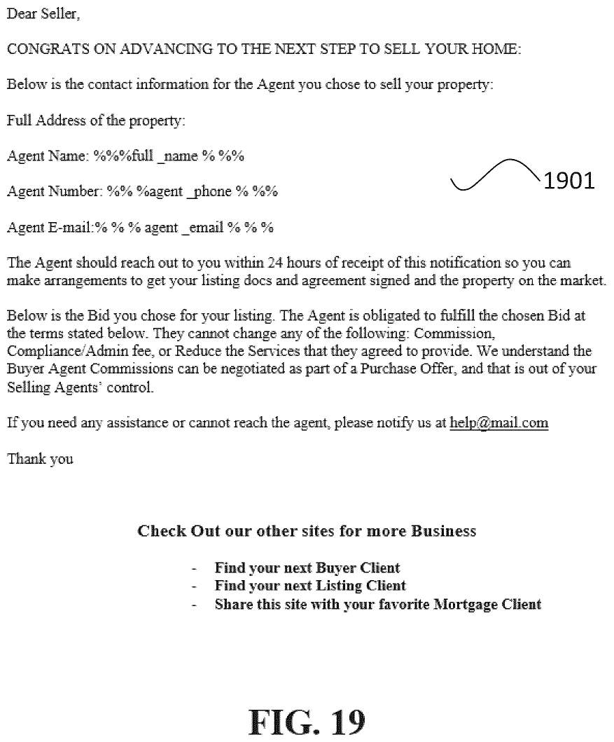

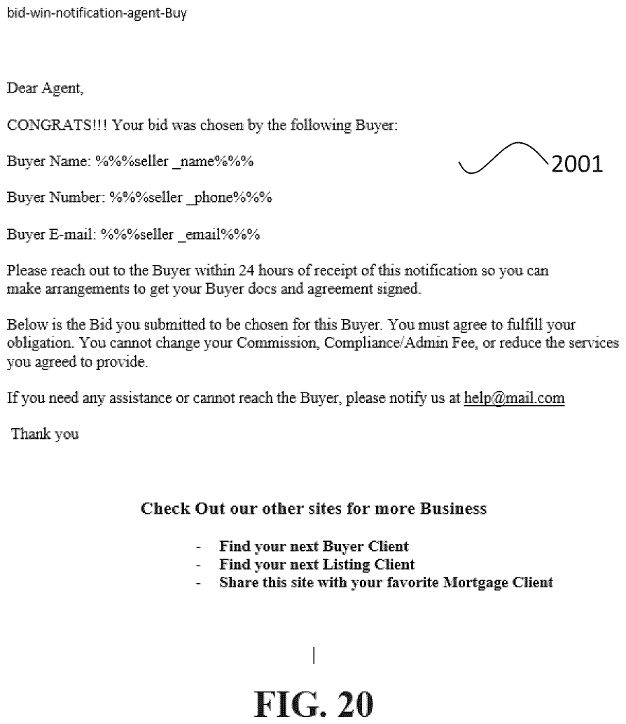

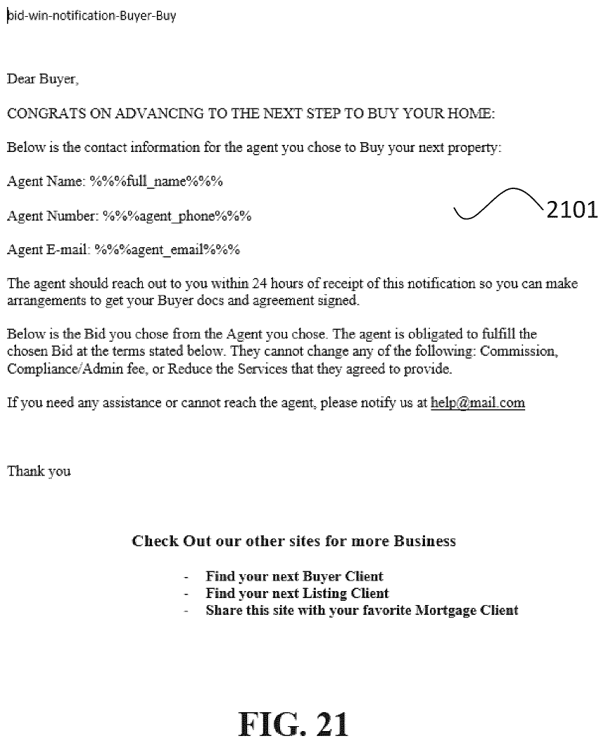

FIG. 2 also depicts sending contemporaneous emails to reveal mutual contact information. FIGS. 18 and 19 represent contemporaneous emails to reveal mutual contact information between an accepted real estate selling agent and an accepting seller of real property. Similarly, FIGS. 20 and 21 represent contemporaneous emails to reveal mutual contact information between an accepted real estate selling agent and an accepting seller of real property.

Examples provided below are intended to demonstrate illustrative methods contemplated by the invention and are not intended to limit particular terms or concepts set forth therein to the illustrative examples of those concepts provided. Certainly, to the extent other portions of this description provide expansive notions for such concepts, the concepts are not to be limited to the variants illustratively described below. In general, reasonable variants of any concept that would be readily understood by skilled artisans are contemplated.

Illustrative methods may include, for example, a method of receiving input associated with an anonymous electronic interaction wherein each anonymous interaction comprises input associated with a particular buyer or seller of real property and input associated with each qualified real estate agent. The method may comprise associating two or more input variables, fields or parameters to a standardized bid template or instance thereof; and receiving input associated with a real estate agent. The method may further comprise receiving input associated with a buyer or seller of real property and provisioning a time-limited bid session for each particular buyer or seller of real property. Each time-limited bid session may be associated with an anonymous electronic interaction. The method may comprise discovering qualified real estate agents for each particular buyer or seller of real property by matching input associated with a particular buyer or seller of real property and input associated with each real estate agent. The method may comprise provisioning a standardized bid template or instance thereof for each qualified real estate agent. The method may comprise receiving input associated with the anonymous electronic interaction. The anonymous interaction may comprise input anonymously associated with the particular buyer or seller of real property and input anonymously associated with each of the qualified real estate agents. The input anonymously associated with each of the real estate agents may comprise input associated with updating the current state of the standardized bid template or instance thereof. The input anonymously associated with the particular buyer or seller may comprise input associated with accepting or rejecting the current state of the standardized bid template or instance thereof.

An illustrative system (web-based, app-based, etc.) for receiving input associated with an anonymous electronic interaction, wherein, in this example, each anonymous interaction may comprise input associated with a particular buyer or seller of real property and input associated with each qualified real estate agent, may be provided.

The system may include one or more processors configured, by computer readable storage medium, such an non-transitory medium, to execute exemplary, non-limiting steps as discussed below. Partial execution of such steps to achieve partial usable results, as well as additional steps, are contemplated.

The steps the system undertakes may include association of two or more input variables, fields or parameters to a standardized bid template or instance thereof. The steps the system undertakes may include receipt of input associated with a real estate agent and receipt of input associated with a buyer or seller of real property. The steps the system undertakes may include provisioning a TimeLimited Bid Session or a BidLimited Bidd Session for each particular buyer or seller of real property. Each TLBS or BLBS may be associated with an anonymous electronic interaction. The steps the system undertakes may include discovering qualified real estate agents for each particular buyer or seller of real property by matching input associated with a particular buyer or seller of real property and receipt of input associated with each real estate agent. The steps the system undertakes may include provisioning a standardized bid template or instance thereof for each qualified real estate agent.

The steps the system undertakes may include receiving input associated with the anonymous electronic interaction. Each anonymous interaction may includes input anonymously associated with the particular buyer or seller of real property and input anonymously associated with each of the qualified real estate agents. The input anonymously associated with each of the real estate agents may include input associated with updating the current state of the standardized bid template or instance thereof. The input anonymously associated with the particular buyer or seller may include input associated with accepting or rejecting the current state of the standardized bid template or instance thereof.

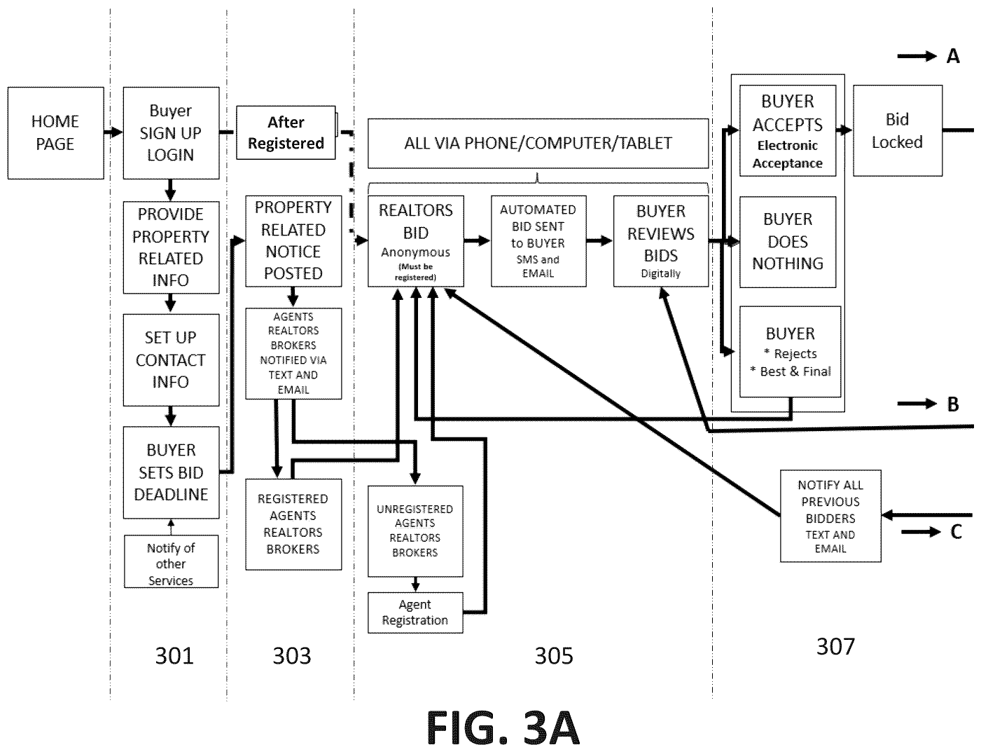

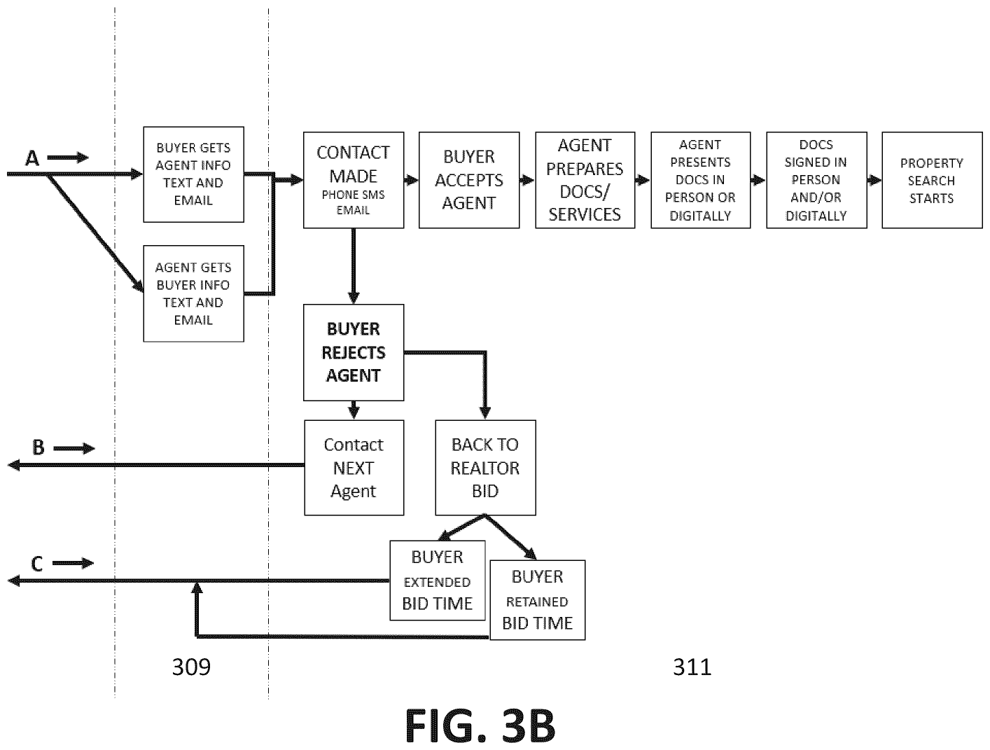

FIGS. 3A and 3B show an illustrative flow diagram of an implementation of a system or method for anonymous competitive offerings (e.g., bidding) that is, in this example, without limitation, a buyer-only site for assisting buying agents and buyers of real property. While not shown, similar examples, again without limitation, can include at least similar structures for sellers and assisting selling agents, and for mortgage brokers and bankers. This example is a variant of that provided with respect to FIG. 2, although many examples may be similar in nature, and both are non-limiting in scope.

In FIG. 3A Column 301 are exemplary steps for the principal party (here, a buyer) entering the specific information regarding, for example, their registration, description of the home, the area they are searching to purchase a home, and the TimeLimited Bidding Session (TLBS) or BidLimited Bid Session (BLBS).

Column 303 includes post-registration actions, such as, for example, the anonymous notification of the registered qualified assisting agents that a principal party is requesting services. Any matching necessary, to the extent desired, can occur for selection of the assisting agents, it is understood that the phrase “qualified agent” may encompass any selection criteria imposed or necessary, if such selection criteria is utilized. Notification can comprise text, email, app-based notification if an application is used, or other suitable means of conveyance.

Column 305 shows exemplary elements of anonymous communication between the principal party and any registered qualified agents (RQAs). Agents may submit bids, bids may be sent to principal parties via email, text, application, etc., and the principal party may review bids. Also, unregistered agents may be notified of an opportunity and may register (and be qualified if necessary). If the agents are qualified to bid, they may be given an opportunity within the TLBS to bid. Principal parties may also extend the TLBS, for example, responsive to one or more new agents joining a pool of agents, to permit time for bids from the new agents. Extension of the TLBS could extend to all participating agents or be limited for selected agents. Each new agent could also be given a predefined amount of time to participate, even if the TLBS was ended, but an agent had not yet been selected, for example.

Column 307 shows exemplary flows for review of the bids or offers from the RQA. In this example, at this point 307, the principal party has three options: 1) accept one of the bids or offers (E.g., electronically accept); 2) elect to do nothing-which may extend the TLBS or terminate the session if this option is left open for too long; or 3) reject all of the bids and offers and request new bids or, for example, best and final bids. If desired, although not necessary, the lowest rejected bid could be shown to all agents, or other incentivizing behavior could occur. Agents may alternatively be left to guess at the requisite bid, or a buyer could impose a desired ceiling on bidding and interested agents could participate. Other suitable approaches for obtaining a desired bidding structure are also contemplated as would be understood by skilled artisans.

Bids may be locked upon acceptance, which may be binding if such bids are considered to be binding. Bids may be binding subject to final agreement of use of the agent, for example, or may be non-binding as a possible term of engagement. If a selected agent is ultimately rejected, a new agent may be chosen or notified.

In FIG. 3B at column 309 are provided illustrative post-selection steps. This can include, for example, notification to a selected RQA that their bid or offer was accepted by the principal party. That notification may include disclosure of contact information for the principal party, and the principal party may likewise obtain the contact information for the RQA.

Column 311 includes possible process steps for finalization. After contact is made, the principal party has two options: 1) continue to the contract phase with the Accepted RQA; or 2) reject the RQA and return to section 305 and accept a different RQA bid or offer. Alternatively, one or more secondary selected bids/bidders could also be immediately notified if the primary RQA was rejected. Other steps in column 311 can be completed remotely and digitally or in-person as desired.

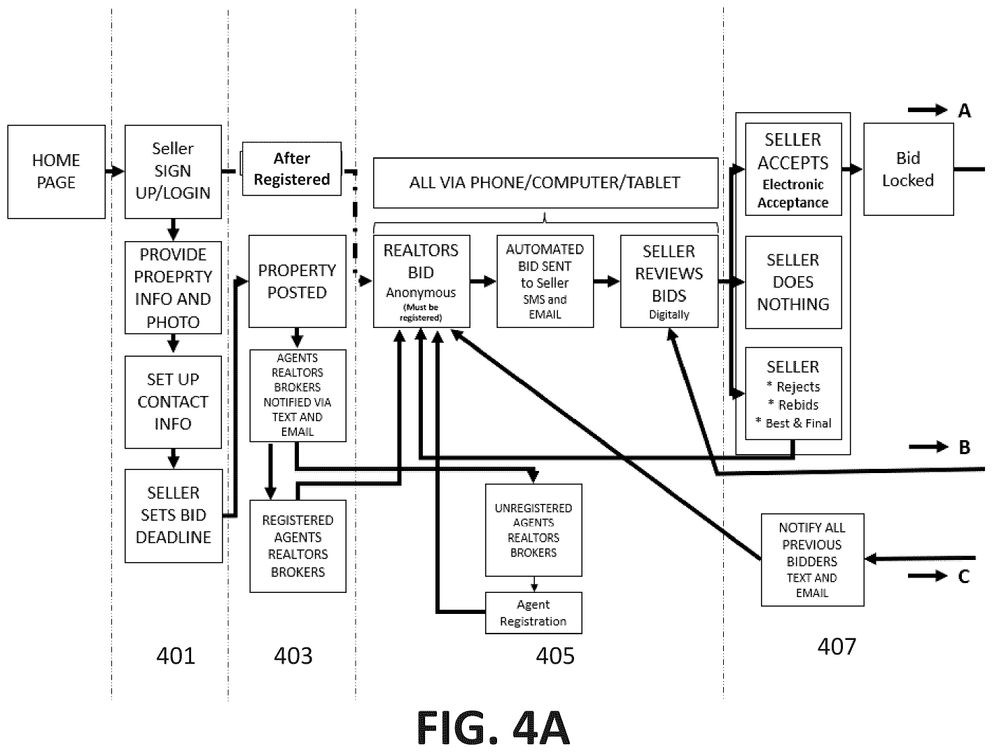

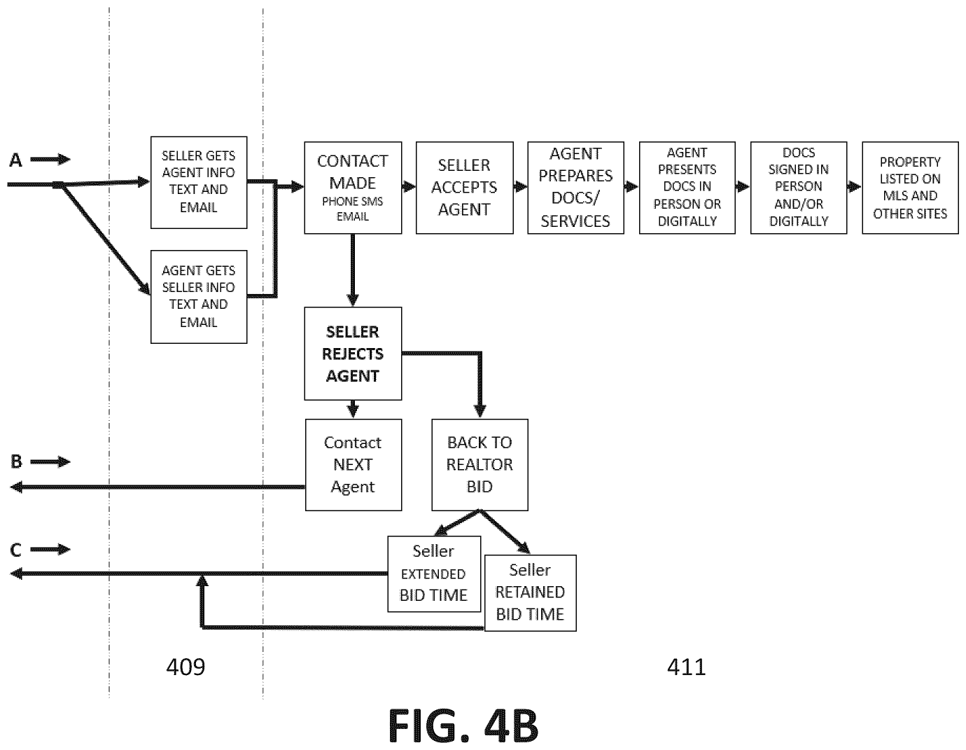

FIGS. 4A and 4B show illustrative process flows for an implementation of a system or method for anonymous competitive offerings that is, in this non-limiting example, a seller-only site for assisting agents and principal parties selling real property.

Column 401 is similar to column 301, although the seller would provide property information of the asset as opposed to information pertaining to a desired asset. Column 403 is similar to column 303 with appropriate differences for sellers vs buyers to be understood to be encompassed by terms common to both columns (as is the case for all columns in this example). Columns 405 and 407 likewise track columns 305 and 307 with understood changes for the seller vs. buyer paradigm—e.g., without limitation, bids may be for seller commission on the seller side and bids may be for buyer agent contribution to closing or required commission on the buyer side—in the buyer agent case, the commission may be fixed by a seller agent and the buyer agent could offer to contribute some percentage, down to a minimum collected-commission, to the process. Similarly, columns 409 and 411 are comparable to columns 309 and 311. In this example, and potentially applicable to both examples here and in FIG. 3B, the principal party can elect to extend the bid time or have a rebid session as necessary upon rejection of a particular agent.

FIG. 5 shows an illustrative example of an agent form 501. This can include, for example, email, passwords, licensing credentials and any other information pertinent to the process as dictated by a given platform. If necessary, this could include awards, affiliations, experience, sales numbers, etc. The information may be verified, to the extent possible, by the backend or may be required to be linked from a verifiable source. Similarly, sales numbers or other information, if requested, could be backed-up with included data uploaded with account creation.

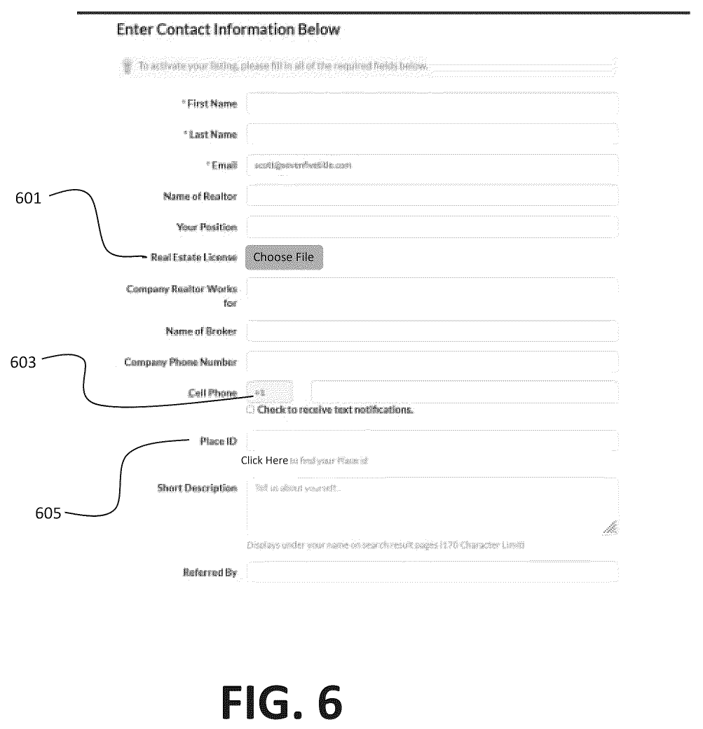

FIG. 6 shows further illustrative examples of agent information forms. This can include, for example, options to upload data 601, such as licensure data in this example. Other identifying information, such as cell phone numbers 603 and PlaceID 605 can be included. Assisting agents can also include a short description of their practice or personal details. If desired, artificial intelligence agents (AI agents) can parse the descriptions to extract relevant information for categorization of agents.

FIGS. 7 and 8 show illustrative principal party forms. Form 701 is an example of a buyer form. Buyers can elect to publish or not publish their information, which may elicit bids. Buyers can input locations of desired interest, which could include multiple locations as shown. Relevant property details, as shown and as understood to be relevant beyond what is shown, could also be included—e.g., without limitation, bedrooms, bathrooms, sq footage, desired price range, etc. Timing for competitive offer submission can also be defined. Such timing may start when the request is published to the assisting agents or at other suitable times.

Form 801 is similar to form 701 but, being a seller form, may include specific details about a property. Sellers and buyers can cross-register—e.g., one person may have an account of each type. Options to import details can be provided. If the seller, for example, wants a comparable new home (in price, sq footage, room sizes, room types, etc.), the buyer form may be partially or fully auto-populated. This can allow a person to create a seller account and then quickly populate a buyer account as well, while ensuring that parameters for housing are within their current standards. This may be particularly useful for someone seeking to move for reasons untreated to upgrading or downgrading a house, but who is comfortable with their price point, sq footage, room count, etc. and wants a similar situation elsewhere.

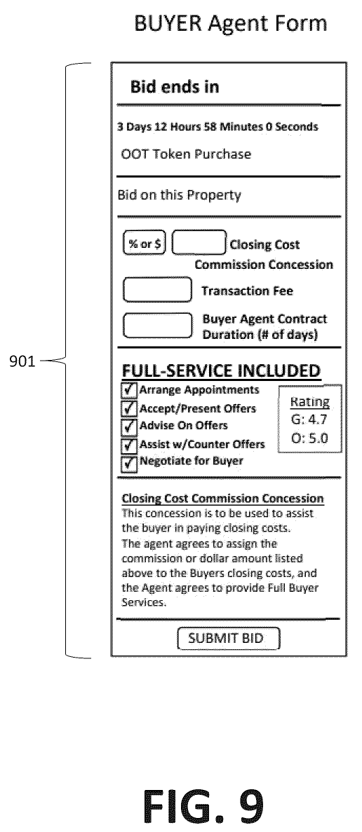

FIG. 9 shows an illustrative assisting agent form that, in this instance, is an illustrative buyer agent form. Agents can include concessions as % or $, transaction fees, contract durations, service provided (as well as ratings, which may be pulled from independent sites), etc. The form may include an explanation of what is being provided or offered to a buyer. If the form is intended to be binding, that may be indicated and the form may be configured to receive an electronic signature as well. Once the agent submits the competitive offer, the offer may pass to the primary party.

In one implementation, a standardized template (e.g., the form shown) or instance thereof may be provided by the system on behalf of each real estate buying agent with the associated variables, fields or parameters in an empty, blank or null state. In another implementation the standardized bid template or form may be provisioned with an initial state having a non-null, non-blank or non-empty state associated with one or more of the two or more associated variables, fields or parameters when such information can be obtained elsewhere. For example, agents may set base parameters for one or more fields as part of their standard offerings. Agents may also set floor or ceiling parameters associated with an account, so the agent does not accidentally enter a bid that is too high or low, such as leaving out a decimal point. The system may also include standardized floors and ceilings to alert an agent to such a mistake, such as require re-entry of the data. The standardized parameters can be based on rational limits or be based on, for example, prior maximums or minimums offered by that agent. If agent employers set up the accounts for new agents, the parameters may be fixed by an organization so the new agent acts within organizational parameters. These parameters may also be defined in a master account for an agency—and if the agent indicates affiliation with that agency, the parameters may be drawn from the corresponding master account. This is likewise true for the seller agent form discussed with respect to FIG. 10.

FIG. 10 shows an illustrative agent form for an assisting seller agent. In this example, an illustrative standardized template or form allows the real estate selling agent to update the state of the standardized bid template or form. In at least one example, the standardized bid template or instance thereof may be provisioned by the system on behalf of each real estate selling agent with the associated variables, fields or parameters in an empty, blank or null state. In another example, it may be provisioned with an initial state having a non-null, nonblank or non-empty state associated with one or more of the two or more associated variables, fields or parameters. The form can be comparably pre-filled in accordance with the discussion of FIG. 9.

This form includes at 1001, but is not limited to, commission prices, buyer commission suggestions, transaction costs, listing durations proposed, services provided, ratings and any extra steps the agent is proposing or willing to take at 1003. Mortgage banker/brokers may use a similar form to offer mortgage services, rates, closing costs and any non-traditional options.

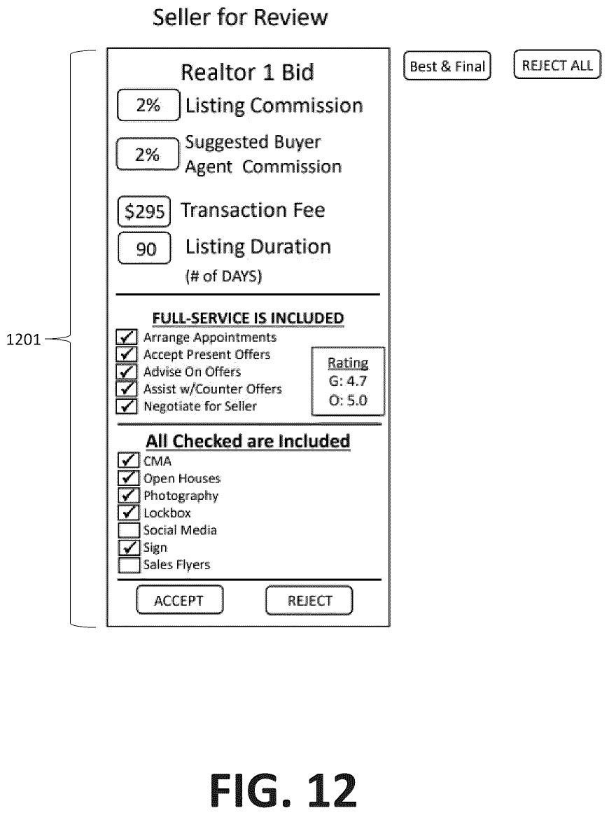

FIGS. 11 and 12 show illustrative examples of screenshots 1101, 1201 for a principal party that shows a competitive offering from a respective assisting agent. In either instance, the party can accept or reject the offer. If desired, an option to counter offer could also be provided, and certain or all fields could be manipulated depending on what can be changed in the counter. Agents may be able to designate what fields can be manipulated, or the system may provide for manipulation of certain or all fields.

FIG. 13 shows a non-limiting example of a screenshot for an implementation of a portal for a particular seller of real property. This includes a customized or dashboard view of a standardized template for the principal party. The principal party has an option to accept or reject the state of the standardized bid template associated with a respective assisting agent. 1301 shows an illustrative seller dashboard where a principal party can review submission of competitive offerings from assisting agents. 1303 shows illustrative seller dashboard account information.

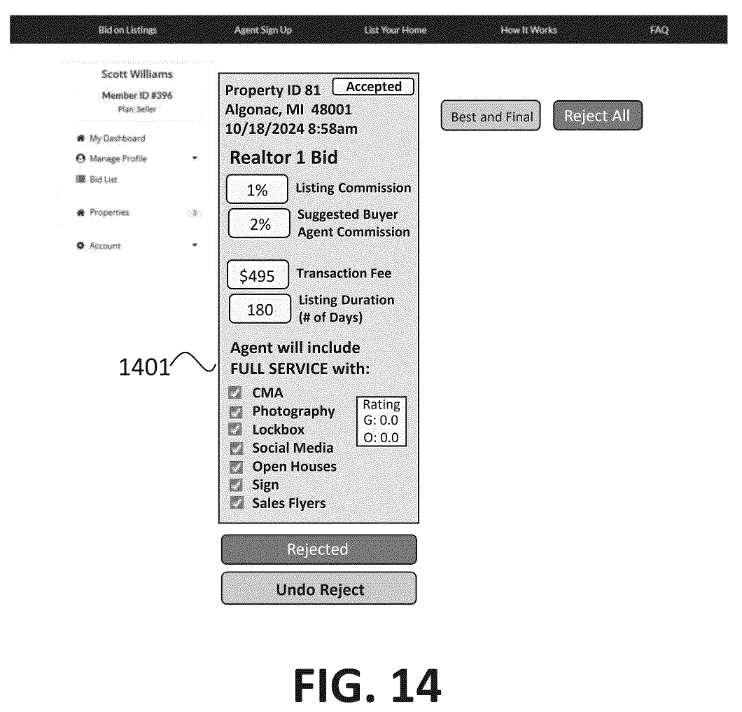

FIG. 14 shows an illustrative example of a screenshot for a portal including a dashboard status screen wherein the seller has rejected the state of a standardized bid template associated with the selling agent but still has an option to undue the rejection. 1401 shows that while the principal party has rejected the bid, the agent is notified via email or texts of rejection and may be allowed to rebid.

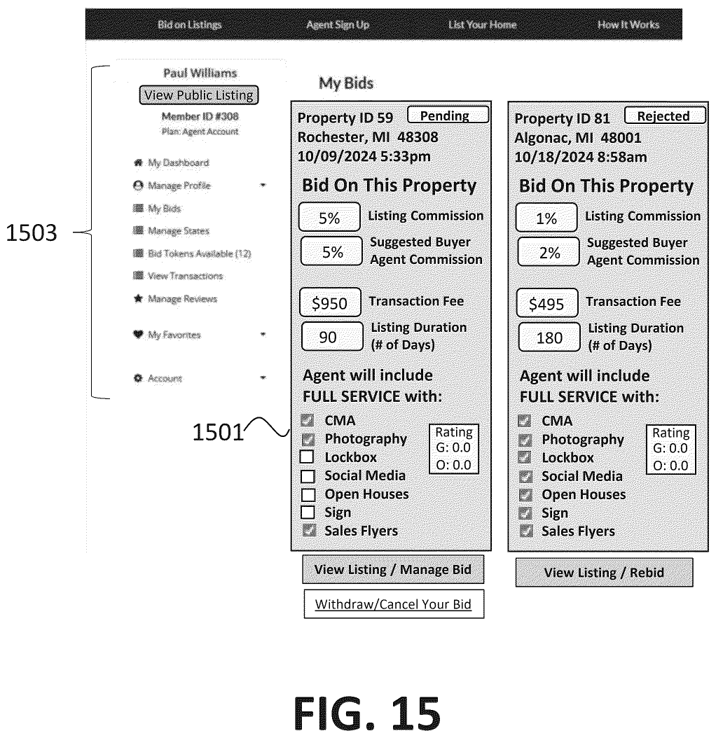

FIG. 15 shows illustrative screenshots for an implementation of a portal for an assisting selling agent. This includes two dashboard status screens, one for each of two different properties wherein the status of a bid on one seller property is pending and the status of a bid on the other seller property is rejected. 1501 is an example of a dashboard showing all active bids the agent has submitted, and in this example the agent can edit any of the active bids. 1503 shows illustrative account information and options.

FIG. 16 shows an illustrative screenshot of an implementation of a portal for a qualified real estate selling agent. This includes a standardized bid template wherein the principal party has accepted the state of the standardized bid template associated with the qualified real estate selling agent. 1601 shows an illustrative agent dashboard where the agent can see list of bids and statuses. Bid Tokens and Bid Coins may be provided and or purchased, Bid Tokens and Bid Coins can limit the number of total outstanding bids, and may be refreshed by purchases of tokens or additional coins, closing properties, closing outstanding bids by rejection, etc. The tokens may be capped to prevent too many outstanding bids and/or too many contracts in place at one time, among other things. The cap may apply even if an agent can buy tokens or coins, to prevent abuse if needed. Tokens may expire at the end of each period (Month or other period to be defined, and Coins may can carry over from one period to the next and beyond). Other paradigms and schema for various ways of controlling total amounts of competitive offerings are also contemplated, and the coin and token examples are not limiting, rather illustrative.

FIG. 17 shows an illustrative screenshot of an implementation of a portal for a qualified real estate buying agent. This includes a standardized bid template wherein the buyer of real property has accepted the state of the standardized bid template associated with the qualified real estate buying agent. 1701 shows an agent dashboard where the agent can see status of accepted bids. Bid tokens may also be used here as described above or in comparable manners.

FIG. 18 shows an illustrative implementation of a message notification from the system, on behalf of an accepting seller, to an accepted selling agent wherein the message notification may include the personal contact information associated with the accepting seller.

FIG. 19 shows an illustrative message notification from the system, on behalf of an accepted selling agent, to the accepting seller of real property wherein the message notification may include the personal contact information associated with the accepted selling agent.

FIG. 20 shows an illustrative message notification from the system, on behalf of an accepting buyer, to the accepted buying agent wherein the message notification may include the personal contact information associated with the accepting buyer.

A similar illustrative message notification from the system, not shown, may be sent on behalf of an accepting buyer, to the accepted mortgage broker/banker wherein the message notification may include the personal contact information associated with the accepting buyer.

FIG. 21 shows an illustrative notification from the system or site, on behalf of an accepted qualified real estate buying agent, to the accepting buyer of real property wherein the email notification may include the personal contact information associated with the accepted qualified real estate buying agent.

A similar illustrative notification from the system or site, not shown, on behalf of an accepted qualified real estate mortgage broker/banker, to the accepting buyer of real property wherein the email notification may include the personal contact information associated with the accepted qualified mortgage broker/banker.

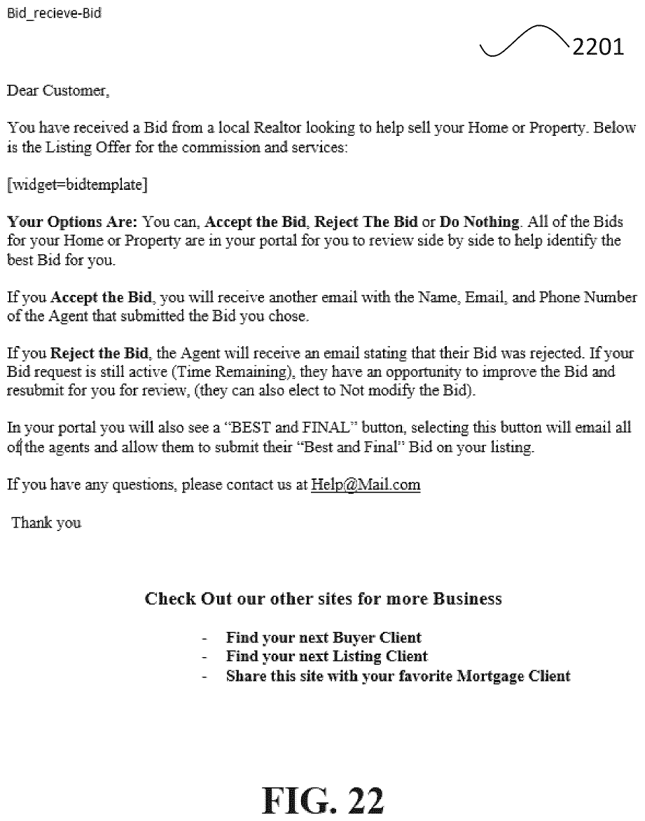

FIG. 22 shows an illustrative anonymous notification from the system or site, on behalf of a qualified real estate selling agent, to the particular seller of real property wherein the anonymous notification may include an alert that a new bid has been made by a qualified real estate selling agent.

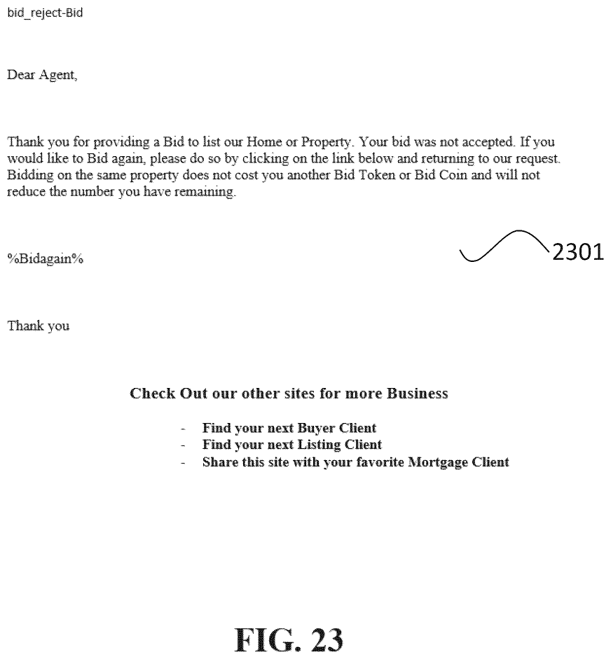

FIG. 23 shows an illustrative anonymous notification from the system, on behalf of a seller of real property, to a qualified real estate selling agent, wherein the anonymous notification may include an alert that a bid associated with the qualified real estate selling agent has been rejected.

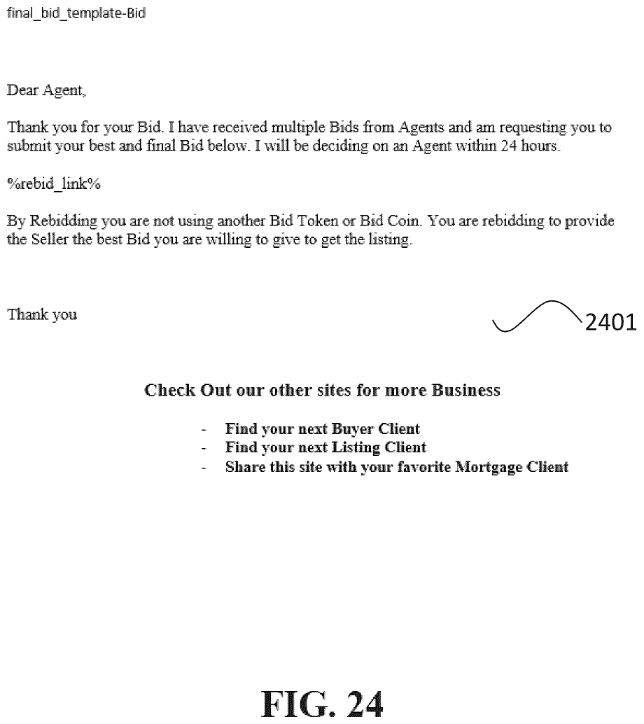

FIG. 24 shows an illustrative anonymous message notification from the system, on behalf of a seller of real property, to each selling agent, wherein the anonymous message notification may include a notice or alert that the seller is requesting a best and final bid from each of the selling agents.

FIG. 25 shows an illustrative anonymous message notification from the system, on behalf of a new seller of real property, to each selling agent, wherein the anonymous message notification may include a notice or alert to each selling agent that the new seller has been made live on the site or system.

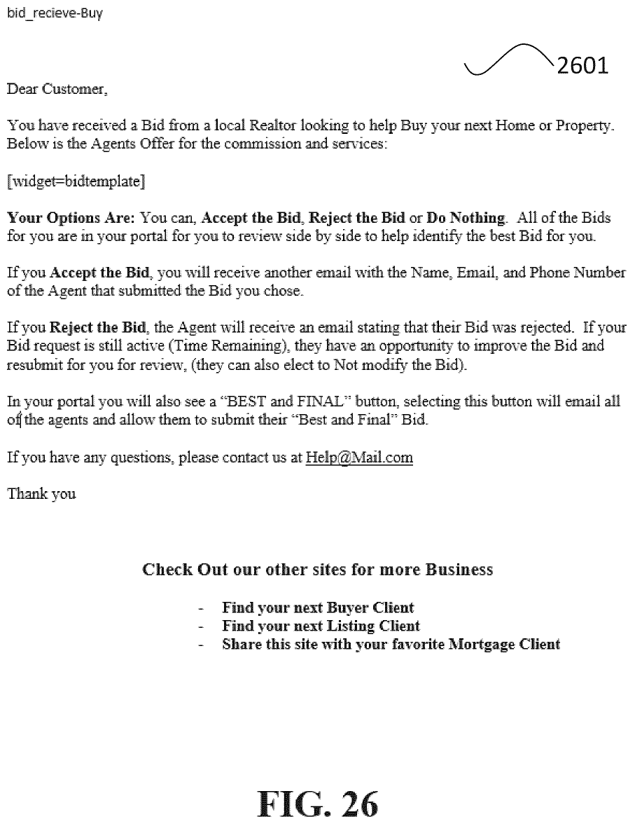

FIG. 26 shows an illustrative anonymous message notification from the system, on behalf of a real estate buying agent, to a buyer of real property wherein the anonymous message notification may include a notice or alert that a bid had been made by the buying agent. The message also may include an explanation of the options available to the buyer of real property including the options of accepting or rejecting the state of the standardized bid template.

A similar illustrative anonymous message notification from the system, not shown, may be sent on behalf of a mortgage broker/banker, to a buyer of real property. The anonymous message notification may include a notice or alert that a bid had been made by the mortgage broker/banker. The message also may include an explanation of the options available to the buyer of real property including the options of accepting or rejecting the state of the standardized bid template.

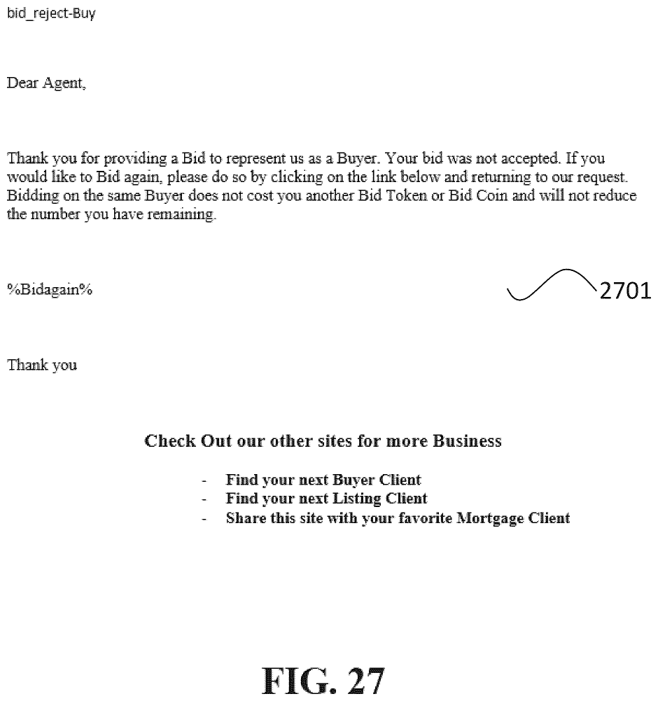

FIG. 27 shows an illustrative anonymous message notification from the system, on behalf of a buyer of real property, to a buying agent. The anonymous message notification may include a notice or alert that the bid associated with the buying agent has been rejected by the buyer of real property.

A similar illustrative anonymous message notification from the system, not shown, may be sent on behalf of a buyer of real property, to a Mortgage Broker/Banker. The anonymous message notification may include a notice or alert that the bid associated with the Mortgage Broker/Banker has been rejected by the buyer of real property.

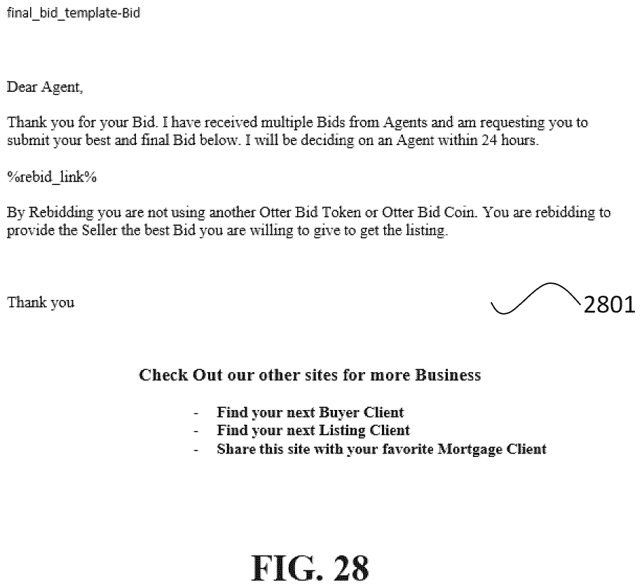

FIG. 28 shows an illustrative anonymous message notification from the system, on behalf of a buyer of real property, to each buying agent. The anonymous message notification may include a notice or alert that the buyer is requesting a best and final bid from each of the buying agents.

FIG. 29 shows an illustrative anonymous message notification from the system, on behalf of a new buyer of real property, to each buying agent. The anonymous message notification may include a notice or alert to each buying agent that the new buyer of real property has been made live on the site or system.

The illustrative embodiments contemplate, but are not limited to, a web-based nationally accessible system and method that may be applied within a regulated industry such as real estate and mortgage companies. The system may be configurable for multiple different sites including buyer-only, seller-only sites, and mortgage only. Each site may allow a plurality of anonymous electronic interactions with each interaction comprising a particular buyer (or seller) of real property and each qualified real estate agent or mortgage broker/banker. The system may automatically discover if each buying or selling agent or mortgage broker/banker is a qualified agent/broker (e.g., geographically) and if so, provision a standardized bid template for the qualified agent or mortgage broker/banker as part of an anonymous electronic interaction. The anonymous electronic interaction may include the particular buyer (or seller) and each qualified agent or mortgage broker/banker thereby allowing each qualified agent or mortgage broker/banker to electronically and anonymously compete for the particular buyer (or seller). If the particular buyer (or seller) accepts the state of a standardized bid template associated with a particular real estate agent or mortgage broker/banker the system may automatically sends contemporaneous emails to reveal personal contact information, mutual contact information between an accepted real estate buying agent or mortgage broker/banker and an accepting buyer of real property.

It is to be understood that the foregoing is a description of one or more illustrative embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to be within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A non-transitory computer readable storage medium storing instructions that, when executed, configure a processor executing the instructions to perform a method comprising:
receiving first input from a principal party seeking assistance with a transactional service, wherein the assistance is sought from at least one assisting agent predefined as qualified to assist with the transactional service and wherein the first input includes identification of the at least one transactional service;
receiving second input from a first plurality of assisting agents, including at least first information indicative of one or more credentials and usable to verify at least one of the one or more credentials and including at least second information identifying at least one area where an inputting assisting agent is qualified, based on at least one of the one or more credentials, to offer assistance with one or more transactional services;
identifying a second plurality of assisting agents, identified by the second input as being agents associated with at least a type of transactional service corresponding to the at least one transactional service, from the first plurality of assisting agents, determined, based on predefined criteria, including at least one of the one or more credentials, to be eligible to assist the principal party with the at least one transactional service;
providing the second plurality of assisting agents with a competitive offering template related to the at least one transactional service, the template determined at least in part based on a predefined nature of the at least one transactional service and having a plurality of predefined alterable fields related to the at least one transactional service;
receiving one or more completed templates from the second plurality of assisting agents;
providing one or more sets of information indicative of the information included in the one or more completed templates to the principal party in a selectable manner, whereby the principal party can select at least one of the sets of information to signal a desire to engage a particular assisting agent responsible for completing a respective template from which the at least one set of information was derived; and
responsive to selection of the at least one of the sets of information, exchanging contact information of the principal party with the particular assisting agent and contact information of the particular assisting agent with the principal party, the contact information of both the principal party and the particular assisting agent having been withheld such that the plurality of second agents lacked the contact information of the principal party at least while completing the competitive offering template and such that the principal party lacked the contact information of the second plurality of assisting agents prior to selection of the at least one set of information.

2. The storage medium of claim 1, wherein the first information includes at least a licensure identification number.

3. The storage medium of claim 2, wherein the method further comprises verifying a validity of the licensure number by communication with an entity providing verification information suitable for verifying the validity.

4. The storage medium of claim 1, wherein the at least one area includes a geographic region within which at least one of the one or more credentials permits the inputting assisting agent to offer assistance.

5. The storage medium of claim 1, wherein one or more of the predefined alterable fields include a pre-filled value fixed upon provision of the template and rendered unalterable for a particular instance of provision of the template.

6. The storage medium of claim 5, wherein the pre-filled value is determined based at least in part on information provided by the principal party indicating a necessary value.

7. The storage medium of claim 1, wherein one or more of the predefined alterable fields include a limitedly alterable value for a particular instance of provision of the template, the value being limited to at least one bound included as data of the template.

8. The storage medium of claim 7, wherein the at least one bound is determined based at least in part on information provided by the principal party indicating the bound.

9. A non-transitory computer readable storage medium storing instructions that, when executed, configure a processor executing the instructions to perform a method comprising:
receiving a request for assistance from an assisting agent to assist with a transactional service identified as part of the request;
determining a first set of criteria for assisting agents that includes one or more assisting agent characteristics indicative of suitability of a given assisting agent for providing assistance with the transactional service;
identifying a plurality of assisting agents having predefined profiles including one or more elements that correspond to a predefined minimum number of the assisting agent characteristics;
providing templates to the identified plurality of assisting agents for obtaining data, corresponding to a plurality of fields within the templates, indicative of a competitive offering from a respective agent to assist with the transactional service and wherein receipt, by at least one of the plurality of assisting agents, of contact information, corresponding to a principal party on whose behalf the request was received and identified with the request, is predicated on completion of the template within a predetermined time period and acceptance, by the principal party, of assistance of a given of the plurality of assisting agents;
receiving a plurality of the templates having been completed and representative of a plurality of competitive offerings;
sending information indicative of the plurality of competitive offerings to the principal party, wherein receipt of contact information, by the principal party, for a given assisting agent responsible for a given of the plurality of competitive offerings, is predicated on acceptance, by the principal party, of the given competitive offering associated with the given assisting agent;
receiving indication that the given competitive offering has been accepted by the principal party; and
responsive to the acceptance of the given competitive offering, providing the contact information corresponding to the principal party to the given assisting agent associated with the accepted given competitive offering and providing the contact information for the given assisting agent to the principal party.

10. The storage medium of claim 9, wherein the predefined minimum number includes all of the assisting agent characteristics.

11. The storage medium of claim 9, wherein the identifying is further based at least in part on the plurality of assisting agents having or more specific elements corresponding to one or more specific ones of the assisting agent characteristics predefined as necessary.

12. The storage medium of claim 9, wherein the predefinition of at least one of the assisting agent characteristics predefined as necessary is based on information included in the request.

13. The storage medium of claim 9, wherein the contact information corresponding to the principal party includes at least one of a phone number or an email address.

14. The storage medium of claim 9, wherein the contact information corresponding to the principal party includes at least a name of the principal party.

15. The storage medium of claim 9, wherein the contact information for the given assisting agent includes at least one of a phone number or an email address.

16. The storage medium of claim 9, wherein the contact information for the given assisting agent includes at least a name of the principal party.

17. The storage medium of claim 9, wherein the predetermined time period is identified in the request.
